(19) United States
(12) Patent Application Publication
(10) Pub. No.: US 2024/0388864 A1
(43) Pub. Date: Nov. 21, 2024

(54) ENVIRONMENTAL ARTIFICIAL INTELLIGENCE SOUNDSCAPE EXPERIENCE

(71) Applicant: Sony Group Corporation, Tokyo (JP)

(72) Inventors: Marvin DeMerchant, San Diego, CA (US); Elizabeth Quepons, San Diego, CA (US); Annie Lin, Cupertino, CA (US); Priyana Patel, Tracy, CA (US); Kara Bates, Montrose, CO (US); Vanessa Chien Lai, Revere, MA (US)

(73) Assignee: Sony Group Corporation, Tokyo (JP)

(21) Appl. No.: 18/488,559

(22) Filed: Oct. 17, 2023

Related U.S. Application Data
(60) Provisional application No. 63/503,259, filed on May 19, 2023.

(51) Int. Cl. H04S 7/00; H04N 21/81

(52) U.S. Cl. CPC H04S 7/301; H04N 21/8106; H04N 21/8146

(57) ABSTRACT

Implementations generally relate to providing an environmental artificial intelligence soundscape experience. In some implementations, a method includes receiving an environmental recording of a target environment, wherein the environmental recording comprises a soundscape recording. The method further includes transmitting the environmental recording to at least one home entertainment system. The method further includes enabling the at least one home entertainment system to present the environmental recording such that a presentation of the environmental recording replicates the target environment in an immersive experience.

### CROSS REFERENCE TO RELATED APPLICATIONS

This application claims priority from U.S. Provisional Patent Application No. 63/503,259, entitled “ENVIRONMENTAL AI SOUNDSCAPE EXPERIENCE,” filed May 19, 2023, which is hereby incorporated by reference as if set forth in full in this application for all purposes.

### BACKGROUND

With the rise of remote work and other effects of social distancing, social connections are no longer limited to face-to-face interactions. Instead, social interactions are heavily informed by our digital environments. Many of the ways people stay connected via social media, however, leave people feeling even more isolated. For example, heavy social media usage is linked to heightened levels of loneliness. Even prior to the COVID-19 pandemic, researchers observed an epidemic of loneliness in America, with 3 in 5 people experiencing loneliness.

### SUMMARY

Implementations generally relate to an environmental artificial intelligence (AI) soundscape experience. In some implementations, a system includes one or more processors, and includes logic encoded in one or more non-transitory computer-readable storage media for execution by the one or more processors. When executed by the one or more processors, the logic is operable to cause the one or more processors to perform operations including: receiving an environmental recording of a target environment, wherein the environmental recording comprises a soundscape recording; transmitting the environmental recording to at least one home entertainment system; and enabling the at least one home entertainment system to present the environmental recording such that a presentation of the environmental recording replicates the target environment in an immersive experience.

With further regard to the system, in some implementations, the soundscape recording comprises 360-degree spatial audio. In some implementations, the soundscape recording comprises augmented reality (AR). In some implementations, the environmental recording comprises one or more images. In some implementations, the environmental recording comprises metadata associated with the target environment. In some implementations, the logic when executed is further operable to cause the one or more processors to perform operations comprising: extracting metadata from the environmental recording; parsing the metadata into sound components and visual components; and transmitting the sound components and visual components to a plurality of media devices, wherein the plurality of media devices presents the sound components and visual components to replicate the target environment. In some implementations, the logic when executed is further operable to cause the one or more processors to perform operations comprising causing lighting associated with the at least one home entertainment system to be displayed based on the soundscape recording.

In some implementations, a non-transitory computer-readable storage medium with program instructions thereon is provided. When executed by the one or more processors, the instructions are operable to cause the one or more processors to perform operations including: receiving an environmental recording of a target environment, wherein the environmental recording comprises a soundscape recording; transmitting the environmental recording to at least one home entertainment system; and enabling the at least one home entertainment system to present the environmental recording such that a presentation of the environmental recording replicates the target environment in an immersive experience.

With further regard to the computer-readable storage medium, in some implementations, the soundscape recording comprises 360-degree spatial audio. In some implementations, the soundscape recording comprises AR. In some implementations, the environmental recording comprises one or more images. In some implementations, the environmental recording comprises metadata associated with the target environment. In some implementations, the instructions when executed are further operable to cause the one or more processors to perform operations comprising: extracting metadata from the environmental recording; parsing the metadata into sound components and visual components; and transmitting the sound components and visual components to a plurality of media devices, wherein the plurality of media devices presents the sound components and visual components to replicate the target environment. In some implementations, the instructions when executed are further operable to cause the one or more processors to perform operations comprising causing lighting associated with the at least one home entertainment system to be displayed based on the soundscape recording.

In some implementations, a method includes: receiving an environmental recording of a target environment, wherein the environmental recording comprises a soundscape recording; transmitting the environmental recording to at least one home entertainment system; and enabling the at least one home entertainment system to present the environmental recording such that a presentation of the environmental recording replicates the target environment in an immersive experience.

With further regard to the method, in some implementations, the soundscape recording comprises 360-degree spatial audio. In some implementations, the soundscape recording comprises AR. In some implementations, the environmental recording comprises one or more images. In some implementations, the environmental recording comprises metadata associated with the target environment. In some implementations, the method further includes: extracting metadata from the environmental recording; parsing the metadata into sound components and visual components; and transmitting the sound components and visual components to a plurality of media devices, wherein the plurality of media devices presents the sound components and visual components to replicate the target environment.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example network environment for providing an environmental artificial intelligence (AI) soundscape experience, which may be used for implementations described herein.

FIG. 2 is an example flow diagram for providing an AI soundscape experience, according to some implementations.

FIG. 3 is a block diagram of an example target environment associated with an environmental AI soundscape experience, according to some implementations.

FIG. 4 is a block diagram of an example home environment associated with an environmental AI soundscape experience, according to some implementations.

FIG. 5 is a block diagram of an example network environment, which may be used for some implementations described herein.

FIG. 6 is a block diagram of an example computer system, which may be used for some implementations described herein.

### DETAILED DESCRIPTION

Implementations described herein enable and facilitate an environmental artificial intelligence soundscape experience. Implementations enable a user to share his or her experience at a given location, referred to herein as a target environment. The user may share a recording of the target environment with other users. Users who receive the recording, also referred to as the environmental recording, may experience the target environment conveniently on their existing home entertainment systems in an ambient, immersive environment grounded in the specific time and place of the target environment.

As described in more detail herein, in various implementations, a system receives an environmental recording of a target environment, wherein the environmental recording comprises a soundscape recording. The system then transmits the environmental recording to at least one home entertainment system. The system then enables the at least one home entertainment system to present the environmental recording such that a presentation of the environmental recording replicates the target environment in an immersive experience.

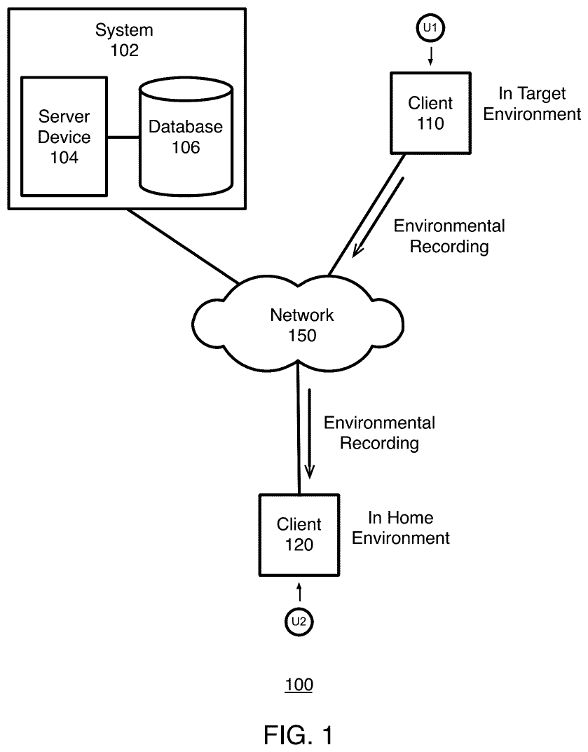

FIG. 1 is a block diagram of an example network environment 100 for providing an environmental artificial intelligence (AI) soundscape experience, which may be used for implementations described herein. In various implementations, network environment 100 includes a system 102, which includes a server device 104 and a database 106. Network environment 100 also includes client devices 110 and 120, which may communicate with system 102 and/or may communicate with each other directly or via system 102. Network environment 100 also includes a network 150 through which system 102 and client devices 110 and 120 communicate. Network 150 may be any suitable communication network such as a Bluetooth network, a Wi-Fi network, the Internet, etc.

For ease of illustration, FIG. 1 shows one block for each of system 102, server device 104, and network database 106, and shows two blocks for client devices 110 and 120. Blocks 102, 104, and 106 may represent multiple systems, server devices, and network databases. Also, each of client devices 110 and 120 may represent a plurality of client devices.

In various implementations, client device 110 may represent a smart phone that a user uses to record the target environment. In various implementations, client device 110 may also represent multiple client devices for capturing different aspects of the target environment. For example, client device 110 may represent one or more sound recorders, one or more cameras, one or more weather station devices, etc., or any combination thereof. Example implementations of these devices and their uses are described in more detail herein.

In various implementations, client device 120 may represent a home entertainment system that includes a variety of media devices. For example, such media devices may include one or more controller devices, multiple speakers such as surround sound speakers, multiple lights, a television, etc., or any combination thereof. Example implementations of these devices and their uses are described in more detail herein. In other implementations, environment 100 may not have all of the components shown and/or may have other elements including other types of elements instead of, or in addition to, those shown herein. For example, other media devices may be included as optional add-on devices to enhance the immersive experience. Such media devices may include, for example, high-quality microphones, 360 sound equipment, different types of speakers such as subwoofers, soundbars, different types of lighting including smart LED lighting systems, augmented reality/virtual reality (AR/VR) headset/glasses, multiple TVs, projectors and/or screens within one or more spaces. In various implementations, a given space with multiple projector screens may simulate a 360 visual experience. In some implementations, the home entertainment system may also include a scene or aroma diffuser that adds a variety of scents to the experience.

While system 102 performs implementations described herein, in other implementations, any suitable component or combination of components associated with system 102 or any suitable processor or processors associated with system 102 may facilitate performing the implementations described herein.

In the various implementations described herein, the processor of system 102 causes the elements described herein (e.g., audio recordings, images, video recordings, and other sensor information, metadata, etc.) to be presented or displayed in a user interface and/or home entertainment system on one or more media devices including display screens, lighting, etc.

In various implementations, the system enables users to enjoy and share captivating sensory experiences specific to their time and selected location. Such sharing enables remote users to feel closer. The system achieves this by combining network communication, data processing, interpretation, signal processing, human-computer interaction, hardware integration, and geolocation techniques. The system may utilize AI to analyze media content with metadata extraction, file format decoding, and image and video processing algorithms to ensure a synchronized, immersive experience that enriches user engagement and enjoyment.

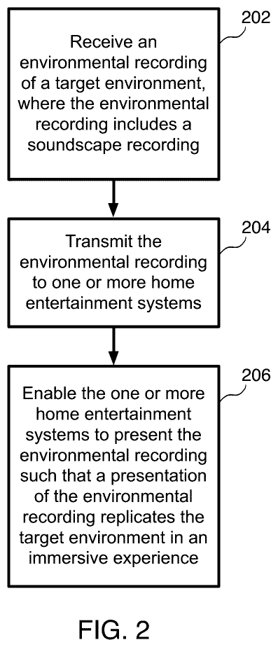

FIG. 2 is an example flow diagram for providing an AI soundscape experience, according to some implementations. Referring to both FIGS. 1 and 2, a method is initiated at block 202, where a system such as system 102 receives an environmental recording of a target environment. The target environment may include any environment where a user is located that the user wishes to share with other users. As described in more detail herein, in various implementations, the environmental recording includes a variety of recordings and metadata associated with the target environment. For example, the environmental recording includes a soundscape recording that captures sound at the target location. The environmental recording and its related components may be collected by a user's smartphone, as well as other types of recording devices. The system stores audio recordings, visual recordings, including metadata associated with lighting, location, etc. based on geolocation and weather data in a database.

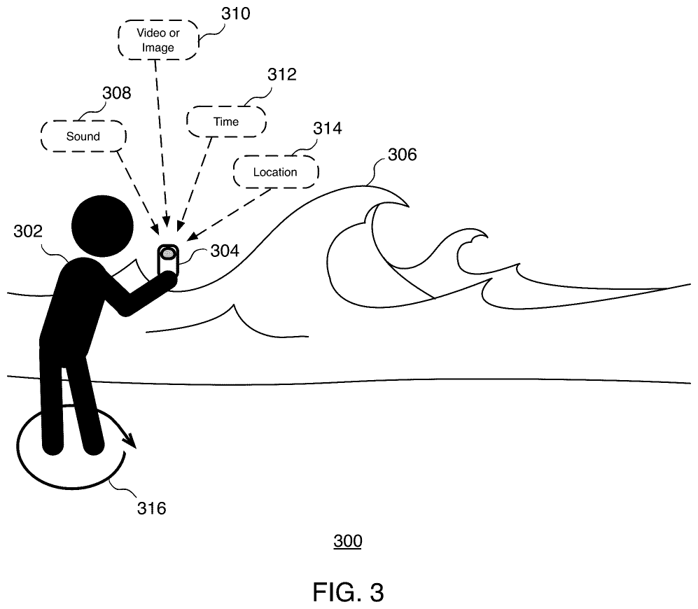

FIG. 3 is a block diagram of an example target environment 300 associated with an environmental AI soundscape experience, according to some implementations. Shown in target environment is a user 302 holding a smartphone 304. User 302 is capturing information associated with target environment 300 using smartphone 304. Shown in the background of target environment 300 are waves 306 of the ocean.

For ease of illustration, user 302 is shown using a single device, smartphone 304, to capture aspects of target environment 300. In various implementation, user 302 may use any number of devices and different types of recording devices to capture aspects of target environment 300. For example, user 302 may set up one or more stand-alone video cameras and recording devices at various positions to capture target environment 300. User 302 may also set up a weather station to collect environmental information about target environment 300 (e.g., temperature, humidity, wind, precipitation, etc.). The system may then store data captured by the various devices as audio recordings, image and/or video recordings, metadata, etc.). The environmental recording described herein may include any combination of this data captured by the various recording devices. As such, smartphone 304 and/or other recording devices may capture sound 308, images and/or video 310, time information 312 (e.g., day, date, time of day, etc.), location information 314 (e.g., geographic location, etc.).

In various implementations, the soundscape recording includes 360-degree spatial audio. The recording changes as the user recording the target environment moves around the target environment. For example, if the user is at the beach and is facing the ocean, the soundscape recording may include sounds of waves 306 crashing. The volume of sound may be at particular decibel level. If the user turns to the right in a rotational pattern 316, and partially away from the crashing waves 306, the system may utilize 360-degree spatial audio techniques to make the sound of the crashing waves 306 louder in decibels in the left-direction audio, and quieter in decibels in the right-direction audio. If the user continues to turn to the right and faces away from the crashing waves 306, the system may utilize 360-degree spatial audio techniques to make the sound of the crashing waves similarly quieter in decibels in both the left- and right-direction audio.

In various implementations, the soundscape recording comprises augmented reality (AR). The system may utilize AI to search for environmental elements associated with the target environment. The system may determine what animals might be present in the target environment and may add such elements to the environmental recording. For example, if a particular animal such as a seagull is native to the target environment, the system may add a recording of a seagull (not shown) to the soundscape sound. The system may simulate a seagull flying from the left to the right of the user by increasing the volume of the sound of an AR seagull in the left ear more than in the right ear as if the seagull were flying toward the user from the left. The system may subsequently increase the volume of the sound of an AR seagull in the right ear more than in the left ear, and attenuate the volume of the sound in the left ear to simulate the seagull flying away from the user and away to the right.

In various implementations, the environmental recording includes one or more images. For example, the environmental recording may include one or more still images of the target environment (e.g., waves of the ocean, etc.). The environmental recording may include one or more videos of the target environment (e.g., waves of the ocean crashing, etc.)

In various implementations, the environmental recording includes metadata associated with the target environment. The system utilizes AI and incorporates various advanced techniques such as geolocation techniques to customize an immersive experience based on the target environment, including real-time data such as current weather conditions and time of day, etc. For example, as indicated above, the environmental recording may include any combination of this data captured by the various recording devices, including time information 312 (e.g., day, date, time of day, etc.), location information 314 (e.g., geographic location, etc.), etc. In various implementations, the metadata may also include voice recordings and/or notes provided by user 302. For example, user 302 may wish to describe or narrate the experience of user 302 to be included with the environment recording to be sent to one or more recipients (e.g., friends, family, etc.).

Referring still to FIG. 2, at block 204, system 102 transmits the environmental recording to one or more home entertainment systems. For example, the system enables the user who originates the environmental recording to send the environmental recording to one or more recipients. For example, in various implementations, smartphone 304 may have an application or existing widget, where user 302 may open soundscapes from a library, and exchange (e.g., send and receive) environmental recordings including soundscapes with other users. The social aspect of exchanging soundscapes may be packaged as data and retrieved from a database once sent to a recipient user. When the system sends the environmental recording to one or more recipients, the system may also send the recipients notifications to let them know that environmental recording has been sent.

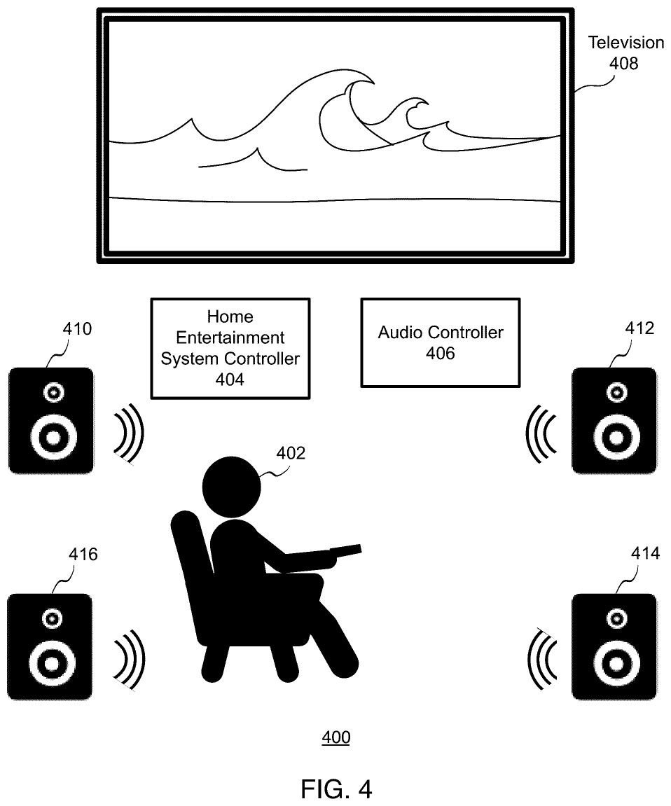

FIG. 4 is a block diagram of an example home environment 400 associated with an environmental AI soundscape experience, according to some implementations. Shown is a user 402 using a home entertainment system that contains various components or media devices. These media devices include, for example, a home entertainment system controller 404, an audio controller 406, and a television 408. In various implementations, audio controller 406 controls various sound devices such as speakers 410, 412, 414, and 416.

For ease of illustration, FIG. 4 shows one block for each of home entertainment system controller 404, audio controller 406, television 408, and shows four blocks for speakers 410, 412, 414, and 416. Blocks 404, 406, and 408 may represent multiple home entertainment system controllers, audio controllers, and televisions. Also, there may be any number of speakers. The scenario shown in home environment 400 of FIG. 4 may represent environments associated with other user recipients of the environmental recording (e.g., sent by user 302 of FIG. 3). The number and types of media devices in a given home entertainment system may vary, and will depend on the particular implementation. In other implementations, environment 100 may not have all of the components shown and/or may have other elements including other types of elements instead of, or in addition to, those shown herein.

The various media devices of the home entertainment system are positioned in a given space such as a living room, entertainment room, etc. or placed around the house. This enables the user to experience the target environment in an immersive manner, where various sounds of a soundscape come from different living space areas to match the target environment.

Referring still to FIG. 2, at block 206, system 102 enables the one or more home entertainment systems such as that shown in FIG. 4 to present the environmental recording. As described in more detail below, the presentation of the environmental recording replicates the target environment in an immersive experience. In various implementations, the system incorporates various audio and lighting devices of the home entertainment system to create an immersive experience, including sound-based augmented reality (sound AR) within a given space in the home of the recipient user. The system utilizes AI to analyze specific time and place data associated with the target environment in order to match the at-home experience using the home entertainment system with real-time conditions associated with the target environment. As such, the system seamlessly integrates the physical target environment with the virtual environment created by the home entertainment system.

In various implementations, the system extracts metadata from the environmental recording. The system then parses the metadata into sound components and visual components associated with the target environment. The system then transmits the sound components and visual components to various media devices. For example, the system may send sound components to audio controller 406 via home entertainment system controller 404. The system may send visual components (e.g., one or more still images, video, etc.) to television 408 via home entertainment system controller 404. In various implementations, the system may utilize AI to cause television 408 to present or show visuals pertaining to the soundscape. For example, the system may cause television 408 to show visuals such as still images, video clips, and/or synchronize live feeds of the target environment. Such visuals may be stored as components of the environmental recording. Alternatively, in some embodiments, the system may utilize AI to fetch crowdsourced images and/or video from the internet to supplement the visual experience. The system may also select visual components based on metadata associated with the target environment and time of day of the environmental recording (e.g., lighting, color, weather, etc.). The system may provide the AI with a training set of sounds, images, and video, as well as other aspects such as lighting to facilitate in making visual selections to enhance the immersive experience.

In various implementations, the media devices of the home entertainment system present the sound components and visual components via the various media devices in the environment (e.g., home environment) of the recipient user (e.g., user 402 of FIG. 4). The combination of sounds and visuals replicate the target environment of the sender user (e.g., user 302 of FIG. 3).

As indicated above, the sound recording of the environmental recording may include 360 spatial audio components to play soundscapes. The system may utilize AI to map out the recipient user's living space, further enhancing the immersive experience including sound AR techniques by playing soundscapes in such a way that the user can experience different sounds in different parts of the room. Such 360 spatial audio components may be played throughout the home or space of the home entertainment system. The environmental recording may also include sound AR. As indicated herein, sound AR may include sounds associated with the target environment (e.g., animal sounds, etc.) that may not have been recorded but that are native to the target environment. Such sound AR may contribute to the ambiance and to the experience of the recipient user to enhance the enjoyment of the target environment.

In various implementations, the system may enable the recipient user (e.g., user 402 of FIG. 4) to walk around the home environment and experience the target environment as if the user were in the target environment. For example, the recipient user may move around the space and rotate in a similar manner as described above with the sender user, and experience the change in the sound of the waves (e.g., changes in sound volume and direction) similarly, as described above.

In various implementations, the system causes lighting associated with the at least one home entertainment system to be displayed based on the soundscape recording. In some scenarios, a home entertainment system may include lighting. The lighting may include lighting from the television and/or other stand-alone lighting in the room. In various implementations, the system may utilize AI to cause the lighting on the television and/or the lighting in the room to match aspects of the environmental recording. In various implementations, the system may match the lighting to the time of day of the environmental recording. For example, the system may make the lighting softer to reflect light at dawn or dusk, or may make the light brighter to reflect mid-afternoon light. In various implementations, the system may match the color or intensity of the light at the target environment. For example, the system may make the light bluer during the early morning or early evening if the sun is not present on the horizon. The system may make the light more orange or red if the sun is present on the horizon to reflect a sunrise or sunset. The system may continually adjust the lighting accordingly during the course of the day.

Another use case may include social events where a given person is unable to attend a social gathering. For example, if a family member could not attend a family reunion, a user at the family reunion may capture the event or target environment, including sounds and images. The user may then send the environmental recording to the family member who missed the event. That family member may experience the event on their home entertainment system to listen to family conversations, as well as view images and/or video of the target environment. In some implementations, the system may utilize AI to collect photos from the event and/or photos of people at the event. The system may then cause the photos to be shown along with audio on the television of the recipient user. As such, the recipient user may have an experience of being with the other family members. In some implementations, the system may enable the recipient user to set filters on the audio components of the environmental recording. For example, the system may enable the user to filter or turn down ambient noise and also to turn up voice sounds in order to make it easier to listen to conversations.

In a use case example involving another target environment such as the Grand Canyon, an environmental recording may include specific attributes of geographic coordinates, time period, and temperature attributes. Based on the retrieved information, the system may utilize AI to calculate how media devices in a home entertainment system may function. For example, if the time of day was in the afternoon, a function could calculate how bright or dim a smart light should be.

In another use case example involving a vacation photo, the environmental recording may include sounds of birds and a waterfall. The system may utilize AI to cause ambient blue lighting on the ceiling and green lighting to emulate foliage around the room. In some implementations, the system may cause other internet of things (IoT) devices such as a smart fan to turn on in order to add a slight breeze. As such, these devices replicate various aspects of the target environment.

In various implementations, the capturing of the environmental recording and a viewing of the environmental recording are asynchronous. For example, after the sender user records the environment, the sender user may subsequently send the recording to one or more recipient users. These recipient users may experience the target environment (e.g., listen to, watch, etc.) when convenient. Alternatively, in some scenarios, one or more of the recipient users may experience the target environment in real-time (e.g., streaming, etc.) as the target environment is being captured. In some implementations, the system may enable the recipient user to select between different AR components to be added to the immersion experience. For instance, the system may enable the user to listen primarily to the sound of the ocean at the target environment or may want add AR sound including sounds of birds in the background. The system may enable the recipient user to save different versions of the environmental recording with different AR components. If some AR components include both video and still pictures, the system may enable the user to save segments of video or still pictures.

In various implementations, the system may enable the user who originated the environmental recording to store the recording for future purposes. For example, that user may wish to reexperience their moment at the target environment at future time. In various implementations, the system may enable the user to augment a past event such as a birthday party by collecting photos and videos from a personal library. As such, the user may relive past moments in time. In various implementations, the system may enable the user who originated the environmental recording to purchase prerecorded sounds to be add to a particular environmental recording. The system may store such prerecorded sounds in a library or playlist.

The following are additional implementations. In various implementations, the system may enable geocaching techniques to enhance immersive environmental AI soundscape experiences. For example, the system may enable users to search and find physical locations that may provide them with unique soundscapes were they to visit those places. The system may enable users to collect (geocache) unique sounds and add them to their library.

In various implementations, the system may enable techniques for mixing and customizing soundscapes to enhance immersive environmental AI soundscape experiences. For example, the system may enable users to create their own unique soundscapes to share with other users. The system may enable a marketplace to house user-generated soundscapes, enabling others to experience such soundscapes as well.

In various implementations, the system may enable live feeds to enhance immersive environmental AI soundscape experiences. For example, the system may enable users to provide live feeds in addition to or in lieu of pre-recorded feeds to reinforce the experience of being in the present. Such live feeds may be auditory (e.g., sound of birds, creeks, waterfalls, etc.) and/or visual (footage of birds, creeks, waterfalls, etc.).

In various implementations, the system may enable business-to-business (B2B) opportunities to enhance immersive environmental AI soundscape experiences. For example, the system may enable specific businesses where users may experience an environmental recording from a store or brand. Businesses such as coffee shops, music artists, and others, may create environmental recording to promote their businesses and create immersive experiences for users to enjoy.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations enable a user to share his or her experience in a given environment with other users who are not present by sharing an environmental recording. Such sharing enables remote users to feel closer. The recipient users may experience the target environment in the comfort of their home via their home entertainment system. By incorporating time and geolocation data, implementations ensure seamless integration of the physical target environment and the virtual immersive environment created by a home entertainment system, adding an unparalleled level of authenticity and immersion.

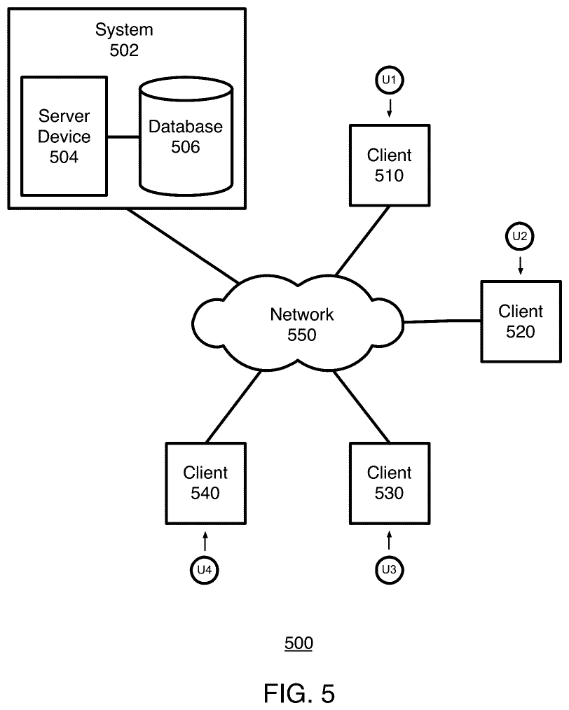

FIG. 5 is a block diagram of an example network environment 500, which may be used for some implementations described herein. In some implementations, network environment 500 includes a system 502, which includes a server device 504 and a database 506. In various implementations, system 502 may be used to implement system 102 of FIG. 1, as well as to perform implementations described herein. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

In various implementations, user U1 may represent user 302 and client 510 may represent smartphone 304 of FIG. 3. Also, user U2 may represent user 402 and client 520 may represent components of the home entertainment system of FIG. 4. The other users U3 and U4 and respective clients 530 and 540 may represent other recipients of the environmental recording and their respective home entertainment systems.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server device 504 of system 502 performs implementations described herein, in other implementations, any suitable component or combination of components associated with system 502 or any suitable processor or processors associated with system 502 may facilitate performing the implementations described herein.

In the various implementations described herein, a processor of system 502 and/or a processor of any client device 510, 520, 530, and 540 cause the elements described herein (e.g., information, etc.) to be displayed in a user interface on one or more display screens.

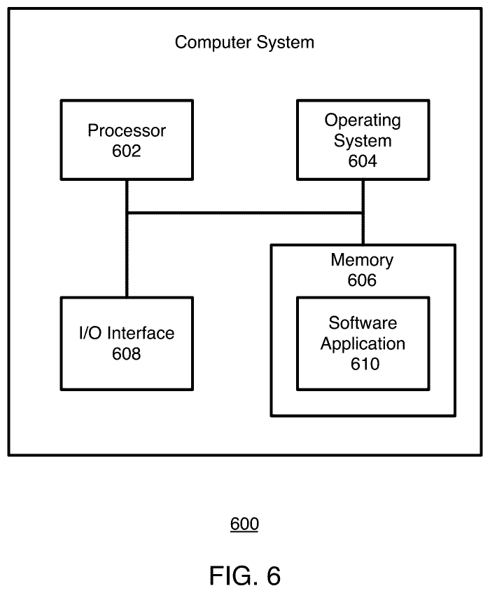

FIG. 6 is a block diagram of an example computer system 600, which may be used for some implementations described herein. For example, computer system 600 may be used to implement server device 504 of FIG. 5 and/or system 102 of FIG. 1, as well as to perform implementations described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
receiving an environmental recording of a target environment, wherein the environmental recording comprises a soundscape recording;
transmitting the environmental recording to at least one home entertainment system; and
enabling the at least one home entertainment system to present the environmental recording such that a presentation of the environmental recording replicates the target environment in an immersive experience.

2. The system of claim 1, wherein the soundscape recording comprises 360-degree spatial audio.

3. The system of claim 1, wherein the soundscape recording comprises augmented reality (AR).

4. The system of claim 1, wherein the environmental recording comprises one or more images.

5. The system of claim 1, wherein the environmental recording comprises metadata associated with the target environment.

6. The system of claim 1, wherein the logic when executed is further operable to cause the one or more processors to perform operations comprising:
extracting metadata from the environmental recording;
parsing the metadata into sound components and visual components; and
transmitting the sound components and visual components to a plurality of media devices, wherein the plurality of media devices presents the sound components and visual components to replicate the target environment.

7. The system of claim 1, wherein the logic when executed is further operable to cause the one or more processors to perform operations comprising causing lighting associated with the at least one home entertainment system to be displayed based on the soundscape recording.

8. A non-transitory computer-readable storage medium with program instructions stored thereon, the program instructions when executed by one or more processors are operable to cause the one or more processors to perform operations comprising:
receiving an environmental recording of a target environment, wherein the environmental recording comprises a soundscape recording;
transmitting the environmental recording to at least one home entertainment system; and
enabling the at least one home entertainment system to present the environmental recording such that a presentation of the environmental recording replicates the target environment in an immersive experience.

9. The computer-readable storage medium of claim 8, wherein the soundscape recording comprises 360-degree spatial audio.

10. The computer-readable storage medium of claim 8, wherein the soundscape recording comprises augmented reality (AR).

11. The computer-readable storage medium of claim 8, wherein the environmental recording comprises one or more images.

12. The computer-readable storage medium of claim 8, wherein the environmental recording comprises metadata associated with the target environment.

13. The computer-readable storage medium of claim 8, wherein the instructions when executed are further operable to cause the one or more processors to perform operations comprising:
extracting metadata from the environmental recording;
parsing the metadata into sound components and visual components; and
transmitting the sound components and visual components to a plurality of media devices, wherein the plurality of media devices presents the sound components and visual components to replicate the target environment.

14. The computer-readable storage medium of claim 8, wherein the instructions when executed are further operable to cause the one or more processors to perform operations comprising causing lighting associated with the at least one home entertainment system to be displayed based on the soundscape recording.

15. A computer-implemented method comprising:
receiving an environmental recording of a target environment, wherein the environmental recording comprises a soundscape recording;
transmitting the environmental recording to at least one home entertainment system; and
enabling the at least one home entertainment system to present the environmental recording such that a presentation of the environmental recording replicates the target environment in an immersive experience.

16. The method of claim 15, wherein the soundscape recording comprises 360-degree spatial audio.

17. The method of claim 15, wherein the soundscape recording comprises augmented reality (AR).

18. The method of claim 15, wherein the environmental recording comprises one or more images.

19. The method of claim 15, wherein the environmental recording comprises metadata associated with the target environment.

20. The method of claim 15, further comprising:
extracting metadata from the environmental recording;
parsing the metadata into sound components and visual components; and
transmitting the sound components and visual components to a plurality of media devices, wherein the plurality of media devices presents the sound components and visual components to replicate the target environment.
